(19) United States
(12) Patent Application Publication
(10) Pub. No.: US 2026/0168645 A1
(43) Pub. Date: Jun. 18, 2026

(54) VEHICLE LIGHTING DEVICE AND VEHICLE LIGHTING FIXTURE

(71) Applicant: Toshiba Lighting & Technology Corporation, Kanagawa (JP)

(72) Inventor: Toshihiro HATANAKA, Ehime-ken (JP)

(73) Assignee: Toshiba Lighting & Technology Corporation, Kanagawa (JP)

(21) Appl. No.: 19/262,136

(22) Filed: Jul. 8, 2025

(30) Foreign Application Priority Data
Dec. 12, 2024 (JP) 2024-217594

(51) Int. Cl. F21S 45/48; F21S 41/19

(52) U.S. Cl. CPC F21S 45/48; F21S 41/192

(57) ABSTRACT

A vehicle lighting device according to an embodiment includes: a socket; a light emitting module, provided on one end side of the socket and including a light emitting element; and a heat transfer part, provided between the socket and the light emitting module. In the case of being viewed in a direction along a central shaft of the vehicle lighting device, a contour of the heat transfer part includes an arc protruding outward, and a portion of the heat transfer part including the arc is located outside the light emitting module.

### CROSS-REFERENCE TO RELATED APPLICATION

This application claims the priority benefit of Japan application serial no. 2024-217594, filed on Dec. 12, 2024. The entirety of the above-mentioned patent application is hereby incorporated by reference herein and made a part of this specification.

### BACKGROUND

### Technical Field

Embodiments of the disclosure relate to a vehicle lighting device and a vehicle lighting fixture.

### Related Art

From the viewpoints of energy saving and lifespan extension or the like, vehicle lighting devices including a light emitting element such as light emitting diode are becoming widespread in place of vehicle lighting devices including a lamp having filaments. Such vehicle lighting devices include a socket and a light emitting module that is provided on one end side of the socket and includes a light emitting element.

Here, when current flows through the light emitting element, light is emitted from the light emitting element and heat is generated. Due to the generated heat, for example, if the temperature of the light emitting element exceeds a maximum junction temperature, there is a risk that the lifespan of the light emitting element may be shortened, the light emitting element may fail, or the luminous flux emitted from the light emitting element may decrease.

Accordingly, a technology has been proposed in which a metal-containing heat transfer part is provided between the light emitting module and the socket. If the heat transfer part is provided, heat generated in the light emitting module can be easily transferred to the socket. Thus, for example, the temperature of the light emitting element can be prevented from exceeding the maximum junction temperature.

However, in recent years, there has been a demand for an increase in luminous flux. Hence, the current flowing through the light emitting element tends to increase, and the generated heat tends to increase.

Accordingly, there has been a demand for development of a technology capable of efficiently transferring the heat generated in the light emitting module to the socket.

[Patent Literature 1] Japanese Patent Laid-open No. 2016-195099

### SUMMARY

A vehicle lighting device according to an embodiment includes: a socket; a light emitting module, provided on one end side of the socket and including a light emitting element; and a heat transfer part, provided between the socket and the light emitting module. In a case of being viewed in a direction along a central shaft of the vehicle lighting device, a contour of the heat transfer part includes an arc protruding outward, and a portion of the heat transfer part including the arc is located outside the light emitting module.

### BRIEF DESCRIPTION OF THE DRAWINGS

FIG. 1 is a schematic exploded view for illustrating a vehicle lighting device according to the present embodiment.

FIG. 2 is a cross-sectional view taken along line A-A of the vehicle lighting device in FIG. 1.

FIG. 3 is a schematic perspective view for illustrating a heat transfer part.

FIG. 4 is a schematic plan view for illustrating a heat transfer part according to another embodiment.

FIG. 5 is a schematic plan view for illustrating a heat transfer part according to another embodiment.

FIG. 6A and FIG. 6B are schematic perspective views for illustrating a heat transfer part according to another embodiment.

FIG. 7 is a schematic cross-sectional view for illustrating a vehicle lighting device provided with a heat transfer part.

FIG. 8 is a schematic partial cross-sectional view for illustrating a vehicle lighting fixture.

### DESCRIPTION OF THE EMBODIMENTS

The disclosure provides a vehicle lighting device and a vehicle lighting fixture in which heat generated in a light emitting module can be efficiently transferred to a socket.

According to an embodiment of the disclosure, a vehicle lighting device and a vehicle lighting fixture can be provided in which heat generated in a light emitting module can be efficiently transferred to a socket.

Hereinafter, embodiments will be illustrated with reference to the drawings. In each drawing, similar components are denoted by the same reference numerals, and detailed descriptions are appropriately omitted.

### Vehicle Lighting Device

A vehicle lighting device 1 according to the present embodiment can be provided in, for example, an automobile or a railway vehicle. Examples of the vehicle lighting device 1 provided in an automobile include one used in a front combination light (for example, one in which a daytime running lamp (DRL), a position lamp, a turn signal lamp and the like are appropriately combined) and a rear combination light (for example, one in which a stop lamp, a tail lamp, a turn signal lamp, a back lamp, a fog lamp and the like are appropriately combined). However, the application of the vehicle lighting device 1 is not limited thereto.

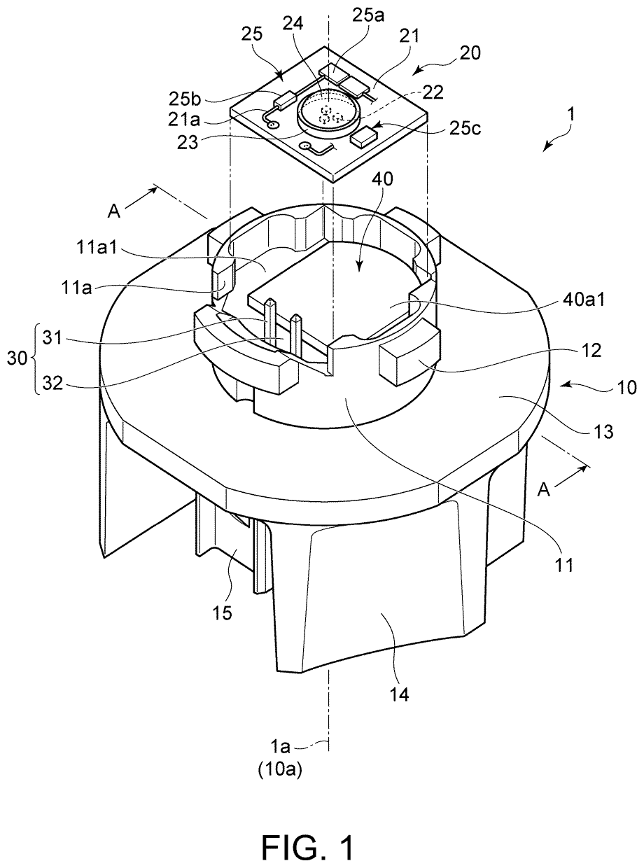

FIG. 1 is a schematic exploded view for illustrating the vehicle lighting device 1 according to the present embodiment.

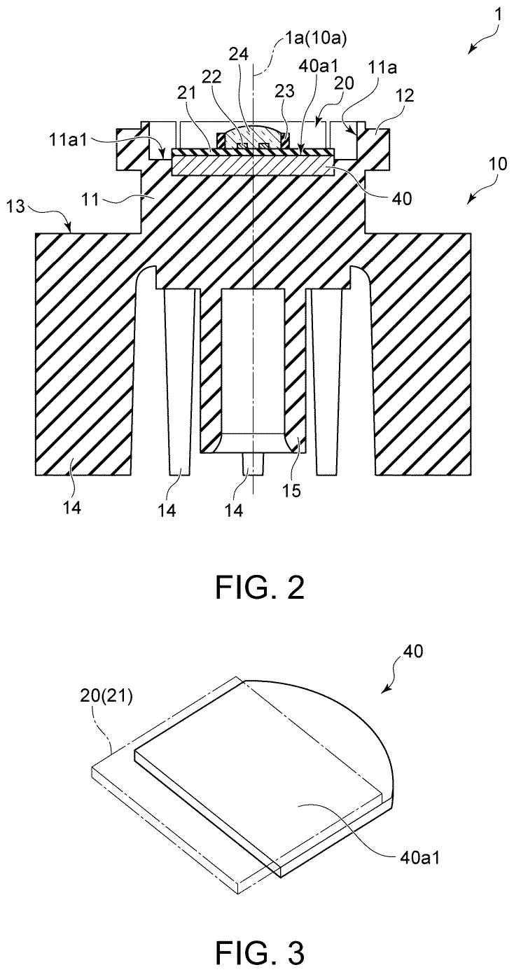

FIG. 2 is a cross-sectional view taken along line A-A of the vehicle lighting device 1 in FIG. 1.

As shown in FIG. 1 and FIG. 2, the vehicle lighting device 1 is provided with, for example, a socket 10, a light emitting module 20, a power supply part 30, and a heat transfer part 40.

The socket 10 includes, for example, a mounting part 11, a bayonet 12, a flange 13, a heat dissipation fin 14, and a connector holder 15.

The mounting part 11 is provided on one surface side of the flange 13. An external shape of the mounting part 11 is, for example, a substantially columnar shape. The mounting part 11 includes, for example, a recess 11a that opens at an end opposite to the flange 13 side.

The bayonet 12 is provided, for example, on a side part of the mounting part 11. The bayonet 12 protrudes toward the outside of the vehicle lighting device 1. The bayonet 12 faces the flange 13. Multiple bayonets 12 can be provided. The bayonet 12 is used in mounting the vehicle lighting device 1 to, for example, a housing 101 of a vehicle lighting fixture 100 described later. The bayonet 12 can be used in a twistlock.

The flange 13 has a plate shape. A side part of the flange 13 is located outward of the vehicle lighting device 1 relative to a side part of the bayonet 12.

The heat dissipation fin 14 is provided on a side of the flange 13 opposite to the mounting part 11 side. At least one heat dissipation fin 14 can be provided. For example, in the case of providing multiple heat dissipation fins 14, as shown in FIG. 1 and FIG. 2, the multiple heat dissipation fins 14 can be provided side by side in a predetermined direction. The heat dissipation fin 14 has, for example, a plate shape or a tubular shape.

The connector holder 15 is provided on a side of the flange 13 opposite to the mounting part 11 side.

The connector holder 15 can be provided side by side with the heat dissipation fin 14. The connector holder 15 has a tubular shape, inside which a connector 105 including a sealing member 105a is inserted.

The socket 10 has a function of holding the light emitting module 20 and the power supply part 30, and a function of transferring heat generated in the light emitting module 20 to the outside. Hence, the socket 10 is formed from a material having high thermal conductivity. In recent years, it has been desired to reduce the weight of the vehicle lighting device 1, and consequently, to reduce the weight of the socket 10. Hence, the socket 10 is preferably formed from, for example, a highly thermally conductive resin. The highly thermally conductive resin includes, for example, a resin and a filler using an inorganic material. The highly thermally conductive resin is, for example, obtained by mixing a resin such as polyethylene terephthalate (PET) or nylon with a filler using carbon, aluminum oxide, or the like.

The light emitting module 20 (substrate 21) is provided on one end side of the socket 10. For example, the light emitting module 20 is provided at an end 40a1 of the heat transfer part 40 that is exposed from the socket 10.

The light emitting module 20 includes, for example, a substrate 21, a light emitting element 22, a frame part 23, a sealing part 24, and a circuit element 25.

The substrate 21 is, for example, adhered to the end 40a1 of the heat transfer part 40. In this case, the adhesive is preferably an adhesive having high thermal conductivity. For example, the adhesive can be an adhesive mixed with a filler using an inorganic material.

The substrate 21 has a plate shape. A planar shape (the shape in the case of being viewed in a direction along a central shaft 1a of the vehicle lighting device 1) of the substrate 21 is, for example, a substantially quadrangular shape. The substrate 21 can be formed from, for example, an inorganic material such as ceramics (for example, aluminum oxide or aluminum nitride) or an organic material such as paper phenol or glass epoxy. The substrate 21 may be a metal core substrate in which a surface of a metal plate is covered with an insulating material. If the light emitting element 22 has a large amount of heat generation, the substrate 21 is preferably formed using a material having high thermal conductivity from the viewpoint of heat dissipation. Examples of the material having high thermal conductivity include ceramics such as aluminum oxide or aluminum nitride, a highly thermally conductive resin, and a metal core substrate. The substrate 21 may have a single-layer structure or a multi-layer structure.

A wiring pattern 21a is provided on a surface of the substrate 21. The wiring pattern 21a is formed from, for example, a material having silver as a main component or a material having copper as a main component. A covering part that covers the wiring pattern 21a or a film-like resistor described later can also be provided. The covering part may include, for example, a glass material.

The light emitting element 22 is provided on the substrate 21 (on a surface of the substrate 21 opposite to the heat transfer part 40 side). The light emitting element 22 is electrically connected to the wiring pattern 21a.

At least one light emitting element 22 can be provided. In the case of providing multiple light emitting elements 22, the multiple light emitting elements 22 can be connected in series.

The light emitting element 22 may be, for example, a light emitting diode, an organic light emitting diode, or a laser diode.

The light emitting element 22 may be a chip-like light emitting element, a surface-mount type light emitting element such as a plastic leaded chip carrier (PLCC) type light emitting element, or a light emitting element including a lead wire such as a bullet type light emitting element. The light emitting element 22 illustrated in FIG. 1 and FIG. 2 is a chip-like light emitting element. In this case, considering reduction in size of the light emitting module 20 and consequently reduction in size of the vehicle lighting device 1, a chip-like light emitting element is preferable. In the following, as an example, a case where the light emitting element 22 is a chip-like light emitting element will be described.

The light emitting element 22 of a chip-like shape can be mounted on the wiring pattern 21a by chip on board (COB). The light emitting element 22 of a chip-like shape may be any of an upper electrode type light emitting element, an upper and lower electrode type light emitting element, and a flip chip type light emitting element.

The frame part 23 is provided on the substrate 21. The frame part 23 is adhered to the substrate 21. The frame part 23 has a frame shape and surrounds the light emitting element 22. The frame part 23 can be formed from, for example, a thermoplastic resin.

The frame part 23 may have a function of defining a formation range of the sealing part 24 and a function of a reflector. Hence, the frame part 23 may include particles of titanium oxide or the like or may include white resin, in order to improve reflectivity.

The frame part 23 may also be omitted. However, if the frame part 23 is provided, the utilization efficiency of light emitted from the light emitting element 22 can be improved. Since a range in which the sealing part 24 is formed can be reduced, the light emitting module 20 can be reduced in size, and consequently, the vehicle lighting device 1 can be reduced in size.

The sealing part 24 is provided inside the frame part 23. The sealing part 24 is provided to cover a region surrounded by the frame part 23. The sealing part 24 is provided to cover the light emitting element 22. The sealing part 24 includes a resin having light transmissivity. The resin is, for example, silicone resin. The sealing part 24 may also include a phosphor.

If the frame part 23 is omitted, for example, the sealing part 24 of a dome shape is formed on the substrate 21.

If the light emitting element 22 is a surface-mount type light emitting element or is a light emitting element including a lead wire such as a bullet type light emitting element, the frame part 23 and the sealing part 24 may be omitted.

The circuit element 25 may be a passive element or active element that may be used to configure a light emitting circuit including the light emitting element 22. The circuit element 25 is, for example, provided around the frame part 23 and is electrically connected to the wiring pattern 21a.

The circuit element 25 may be, for example, a resistor 25a, a protection element 25b, and a control element 25c.

However, the type of the circuit element 25 is not limited to those mentioned as examples, and can be appropriately changed according to the configuration of the light emitting circuit including the light emitting element 22. For example, the circuit element 25 may be, in addition to those described above, a capacitor, a positive temperature coefficient thermistor, a negative temperature coefficient thermistor, an inductor, a surge absorber, a varistor, a transistor, an integrated circuit, and or arithmetic element.

The resistor 25a is provided on the substrate 21. The resistor 25a is electrically connected to the wiring pattern 21a. The resistor 25a may be, for example, a surface-mount type resistor, a resistor (metal oxide film resistor) including a lead wire, a film-like resistor formed using a screen printing method, or the like. The resistor 25a illustrated in FIG. 1 is a film-like resistor. A material of the film-like resistor includes, for example, ruthenium oxide (RuO₂). The film-like resistor is formed using, for example, a screen printing method and a firing method.

The resistor 25a is provided to reduce variations in brightness (luminous flux, luminance, luminous intensity, or illuminance) of light emitted from the light emitting element 22 that are caused by variations in forward voltage characteristics of the light emitting element 22. In this case, by changing a resistance value of the resistor 25a connected in series to the light emitting element 22, the value of current flowing through the light emitting element 22 may fall within a predetermined range.

If the resistor 25a is a surface-mount type resistor or a resistor including a lead wire or the like, the resistor 25a having an appropriate resistance value is selected according to the forward voltage characteristics of the light emitting element 22. If the resistor 25a is a film-like resistor, the resistance value can be increased by removing a portion of the resistor 25a. For example, by irradiating the film-like resistor with laser light, a portion of the film-like resistor can be easily removed.

The resistor 25a may also have a function to prevent excessive current from flowing through the light emitting element 22.

The protection element 25b is provided on the substrate 21. The protection element 25b is electrically connected to the wiring pattern 21a. The protection element 25b is provided, for example, to prevent reverse voltage from being applied to the light emitting element 22 and to prevent pulse noise from a reverse direction from being applied to the light emitting element 22. The protection element 25b may be, for example, a diode or a field-effect transistor. The protection element 25b illustrated in FIG. 1 is a surface-mount type diode.

The control element 25c is provided on the substrate 21. The control element 25c is electrically connected to the wiring pattern 21a. The control element 25c, for example, changes the number of light emitting elements 22 to be lit according to a voltage (input voltage) applied to the vehicle lighting device 1. The control element 25c may, for example, switch the voltage applied to the light emitting element 22 or execute temperature derating.

In addition, an optical element can also be provided as necessary. The optical element can be provided, for example, on the sealing part 24. Examples of the optical element include a convex lens, a concave lens, and a light guide.

The power supply part 30 includes, for example, multiple power supply terminals 31 and a holding part 32.

The multiple power supply terminals 31 may be rod-shaped bodies. The multiple power supply terminals 31 are, for example, provided side by side in one direction. One end of the multiple power supply terminals 31 protrudes from a bottom surface 11a1 of the recess 11a. One end of the multiple power supply terminals 31 is soldered to the wiring pattern 21a provided on the substrate 21. The multiple power supply terminals 31 are electrically connected to the light emitting element 22 and the circuit element 25 via the wiring pattern 21a. The other end of the multiple power supply terminals 31 is exposed inside a hole of the connector holder 15. A connector 105 is fitted to the multiple power supply terminals 31 exposed inside the hole of the connector holder 15. The multiple power supply terminals 31 are formed from, for example, metal such as copper alloy.

As described above, the socket 10 is preferably formed from a material having high thermal conductivity. However, there are cases where materials having high thermal conductivity have conductivity. For example, the highly thermally conductive resin including a filler using carbon has conductivity. Hence, the holding part 32 is provided to insulate between the multiple power supply terminals 31 and the socket 10 having conductivity. The holding part 32 also has a function of holding the multiple power supply terminals 31. If the socket 10 is formed from a highly thermally conductive resin (for example, a highly thermally conductive resin including a filler using aluminum oxide) having insulation properties, the holding part 32 can be omitted. In this case, the socket 10 holds the multiple power supply terminals 31. The holding part 32 is formed from, for example, a resin having insulation properties. The holding part 32, for example, can be press-fitted into a hole provided in the socket 10 or adhered to an inner wall of the hole.

The heat transfer part 40 is provided between the socket 10 and the light emitting module 20.

FIG. 3 is a schematic perspective view for illustrating the heat transfer part 40.

As shown in FIG. 1 to FIG. 3, the heat transfer part 40 has a plate shape. A thickness (dimension in the direction along the central shaft 1a of the vehicle lighting device 1) of the heat transfer part 40 may be, for example, 5 mm or more and 30 mm or less. The heat transfer part 40 is formed from a material having higher thermal conductivity than the highly thermally conductive resin. The heat transfer part 40 can be formed from, for example, metal such as aluminum, aluminum alloy, copper, or copper alloy. Since the heat transfer part 40 having a plate shape can be formed by, for example, press working, manufacturing cost can be reduced.

The heat transfer part 40 is provided on one end side of the socket 10. One end 40a1 of the heat transfer part 40 is exposed from one end of the socket 10. For example, the end 40a1 of the heat transfer part 40 may be a flat surface substantially orthogonal to the central shaft 1a of the vehicle lighting device 1.

The heat transfer part 40 can be, for example, embedded in the bottom surface 11a1 of the recess 11a, as shown in FIG. 2. The heat transfer part 40 can be provided on the bottom surface 11a1 of the recess 11a, or the heat transfer part 40 can be provided on a top surface of a convex part provided on the bottom surface 11a1 of the recess 11a.

As described above, the light emitting module 20 (substrate 21) is adhered to the end 40a1 of the heat transfer part 40. Hence, it is preferable that the end 40a1 of the heat transfer part 40 be provided at a position protruding from the bottom surface 11a1 of the recess 11a. If the end 40a1 of the heat transfer part 40 protrudes from the bottom surface 11a1 of the recess 11a, it can be suppressed that an adhesive climbs up to the light emitting module 20.

The heat transfer part 40 can be adhered to one end side of the socket 10, can be attached to one end side of the socket 10 via thermal conductive grease (heat dissipation grease), or can be embedded in one end side of the socket 10 by an insert molding method. In this case, it is preferable that the adhesive be an adhesive having high thermal conductivity. For example, the adhesive can be the same as the adhesive that bonds the substrate 21 and the heat transfer part 40 described above. For example, the thermal conductive grease can be obtained by mixing modified silicone with a filler using an inorganic material. The thermal conductivity of the thermal conductive grease is, for example, 1 W/(m·K) or more and 5 W/(m·K) or less.

As shown in FIG. 1 and FIG. 3, in the case of being viewed in the direction along the central shaft 1a of the vehicle lighting device 1, a contour of the heat transfer part 40 includes an arc protruding outward. As shown in FIG. 3, a portion of the heat transfer part 40 including the arc is located outside the light emitting module 20 (substrate 21). In this way, since the heat transfer area between the heat transfer part 40 and the socket 10 can be increased, heat dissipation performance of the heat transfer part 40 can be improved.

For example, the contour of the heat transfer part 40 includes the arc, a pair of straight lines each having one end connected to each of both end points of the arc, and a straight line connecting ends on a side of the pair of straight lines opposite to the arc. For example, the contour of the heat transfer part 40 may have a shape in which one side of a quadrangle is changed to an arc. A central angle of the arc may be, for example, 180° or more and 330° or less.

As described above, if the external shape of the mounting part 11 is a substantially columnar shape, when the heat transfer part 40 is provided on one end side of the socket 10, the center of the arc of the contour can be made to overlap a central shaft 10a of the socket 10. In this way, for example, it becomes easy to provide the heat transfer part 40 in the recess 11a of the mounting part 11.

The central shaft 10a of the socket 10 is also the central shaft 1a of the vehicle lighting device 1.

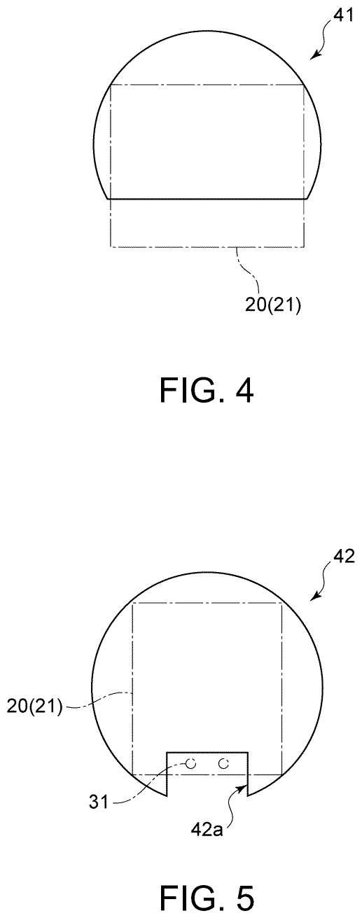

FIG. 4 is a schematic plan view for illustrating a heat transfer part 41 according to another embodiment.

FIG. 4 is a schematic plan view of the heat transfer part 41 in the case of being viewed in a direction along the central shaft 1a of the vehicle lighting device 1.

As shown in FIG. 4, in the case of being viewed in the direction along the central shaft 1a of the vehicle lighting device 1, a contour of the heat transfer part 41 includes an arc protruding outward. As shown in FIG. 4, a portion of the heat transfer part 41 including the arc is located outside the light emitting module 20 (substrate 21). In this way, since the heat transfer area between the heat transfer part 41 and the socket 10 can be increased, heat dissipation performance of the heat transfer part 41 can be improved. For example, the contour of the heat transfer part 41 includes the arc and a chord connecting both end points of the arc. A central angle of the arc may be, for example, 180° or more and 330° or less. For example, the heat transfer part 41 differs from the heat transfer part 40 described above only in the contour in the case of being viewed in the direction along the central shaft 1a of the vehicle lighting device 1.

Similar to the case of the heat transfer part 40, when the heat transfer part 41 is provided on one end side of the socket 10, the center of the arc of the contour can be made to overlap the central shaft 10a of the socket 10. In this way, for example, it becomes easy to provide the heat transfer part 41 in the recess 11a of the mounting part 11.

The heat transfer area between the heat transfer part 41 and the socket 10 can be made larger than the heat transfer area between the heat transfer part 40 and the socket 10, and thus, the heat dissipation performance of the heat transfer part 41 is higher than the heat dissipation performance of the heat transfer part 40.

FIG. 5 is a schematic plan view for illustrating a heat transfer part 42 according to another embodiment.

FIG. 5 is a schematic plan view of the heat transfer part 42 in the case of being viewed in a direction along the central shaft 1a of the vehicle lighting device 1.

As shown in FIG. 5, in the case of being viewed in the direction along the central shaft 1a of the vehicle lighting device 1, a contour of the heat transfer part 42 includes an arc protruding outward. As shown in FIG. 5, a portion of the heat transfer part 42 including the arc is located outside the light emitting module 20 (substrate 21). In this way, since the heat transfer area between the heat transfer part 42 and the socket 10 can be increased, heat dissipation performance of the heat transfer part 42 can be improved. For example, the contour of the heat transfer part 42 includes a shape obtained by notching a portion of a circle. For example, the heat transfer part 42 differs from the heat transfer parts 40 and 41 only in the contour in the case of being viewed in the direction along the central shaft 1a of the vehicle lighting device 1.

As shown in FIG. 1, multiple power supply terminals 31 are exposed on one end side of the socket 10. In the case of the contours of the heat transfer parts 40 and 41, since a straight line portion can be provided facing the multiple power supply terminals 31, the heat transfer parts 40 and 41 can be prevented from contacting the multiple power supply terminals 31. If the contour of the heat transfer part 42 is made circular and the heat transfer part 42 is prevented from contacting the multiple power supply terminals 31, the area of the heat transfer part 42 is excessively reduced, and there is a risk that it may be difficult to provide the light emitting module 20 on the heat transfer part 42 or the heat dissipation performance of the heat transfer part 42 may deteriorate.

Accordingly, as shown in FIG. 5, the heat transfer part 42 is provided with a notch 42a. The notch 42a penetrates the heat transfer part 42 in a thickness direction and opens at a peripheral edge of the heat transfer part 42. Similar to the heat transfer part 40, when the heat transfer part 42 is provided on one end side of the socket 10, the center of the circle of the contour can be made to overlap the central shaft 10a of the socket 10. At this time, the multiple power supply terminals 31 can be located inside the notch 42a. Hence, the heat transfer area between the heat transfer part 42 and the socket 10 can be increased, and the heat transfer part 42 can be prevented from contacting the multiple power supply terminals 31. The heat transfer area between the heat transfer part 42 and the socket 10 can be made larger than the heat transfer area between each of the heat transfer parts 40 and 41 and the socket 10.

Here, if the portion including the arc located outside the light emitting module 20 (substrate 21) is increased, since the heat transfer area with the socket 10 is increased, the heat dissipation performance can be improved. However, since the light emitting module 20 is adhered to the heat transfer parts 40 to 42, if the portion including the arc located outside the light emitting module 20 is increased, the adhesive is likely to climb up to the light emitting module 20. When the adhesive climbs up to the light emitting module 20, there is a risk that the aesthetic appearance may be impaired and the commercial value may decrease. Hence, if the portion including the arc located outside the light emitting module 20 is increased, when the light emitting module 20 is adhered to the heat transfer parts 40 to 42, the amount of adhesive and or application position of the adhesive or the like is strictly managed.

Accordingly, considering the amount of heat generated in the light emitting module 20, the form (for example, the planar shape of the inner wall of the recess 11a) of one end of the socket 10, the productivity in the adhesion process or the like, a heat transfer part having an appropriate contour can be appropriately selected.

By further providing a step 43a2 described later outside a region where the light emitting module 20 is provided in the heat transfer parts 40 to 42, the adhesive can be prevented from climbing up to the light emitting module 20.

In the above, the heat transfer parts 40 to 42 of a plate shape have been illustrated. However, the heat transfer parts 40 to 42 may also further include at least one fin extending inside the socket 10. By providing a fin extending inside the socket 10, the heat transfer area with the socket 10 can further be increased. Thus, the heat dissipation performance can further be improved.

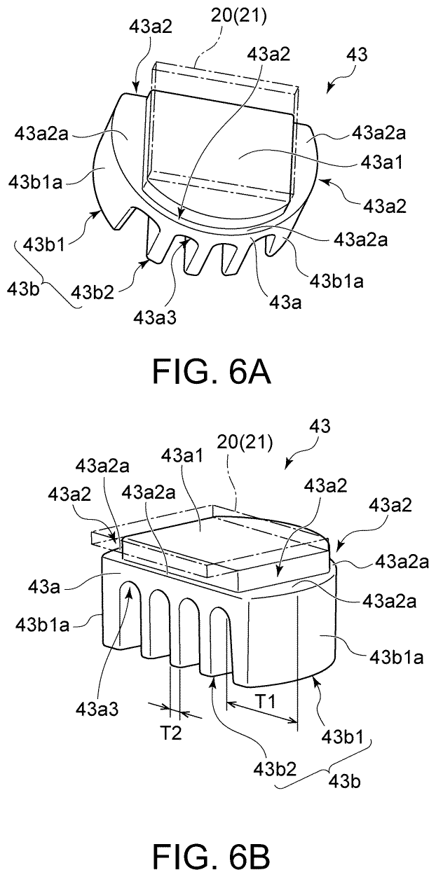

FIG. 6A and FIG. 6B are schematic perspective views for illustrating a heat transfer part 43 according to another embodiment.

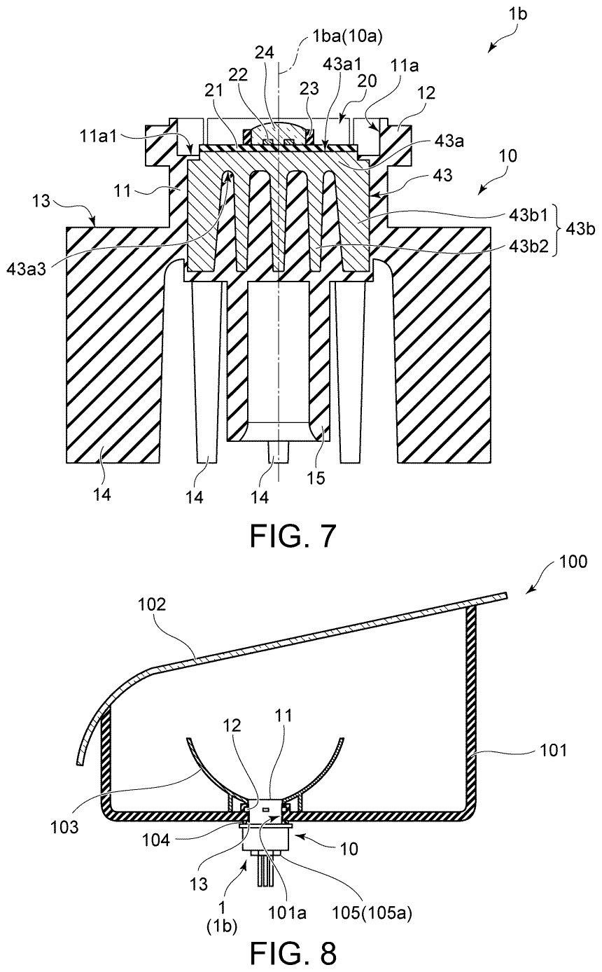

FIG. 7 is a schematic cross-sectional view for illustrating a vehicle lighting device 1b provided with the heat transfer part 43.

As shown in FIG. 7, the heat transfer part 43 is provided between the socket 10 and the light emitting module 20. The heat transfer part 43 can be adhered to one end side of the socket 10, can be attached to one end side of the socket 10 via thermal conductive grease (heat dissipation grease), or can be embedded in one end side of the socket 10 by an insert molding method.

As shown in FIG. 6A and FIG. 6B, the heat transfer part 43 includes a base part 43a and multiple fins 43b. The base part 43a and the multiple fins 43b can be integrally formed. The heat transfer part 43 is formed from a material having higher thermal conductivity than the highly thermally conductive resin. The heat transfer part 43 can be formed from metal such as aluminum, aluminum alloy, copper, or copper alloy.

The base part 43a has, for example, a plate shape. A thickness (dimension in a direction along a central shaft 1ba of the vehicle lighting device 1b) of the base part 43a may be, for example, 2 mm or more and 30 mm or less. A contour of the base part 43a in the case of being viewed in the direction along the central shaft 1ba of the vehicle lighting device 1b may have a shape including an arc. For example, as shown in FIG. 6A and FIG. 6B, the contour of the base part 43a includes the arc and a chord connecting both end points of the arc. A central angle of the arc may be 180° or more and 330° or less.

As shown in FIG. 7, the base part 43a can be embedded in the bottom surface 11a1 of the recess 11a. The base part 43a can be provided on the bottom surface 11a1 of the recess 11a, or the base part 43a can be provided on the top surface of the convex part provided on the bottom surface 11a1 of the recess 11a. For example, an end 43a1 of the base part 43a is exposed from the bottom surface 11a1 of the recess 11a. For example, the end 43a1 of the base part 43a may be a flat surface substantially orthogonal to the central shaft 1ba of the vehicle lighting device 1b.

In the case of being viewed in the direction along the central shaft 1ba of the vehicle lighting device 1b, a contour of the end 43a1 includes an arc protruding outward. For example, as shown in FIG. 6A and FIG. 6B, the contour of the end 43a1 includes an arc extending along a peripheral end of the base part 43a, a pair of straight lines each having one end connected to each of both end points of the arc, and a straight line connecting ends on a side of the pair of straight lines opposite to the arc. For example, the contour of the end 43a1 may have a shape in which one side of a quadrangle is changed to an arc. A central angle of the arc may be 180° or more and 330° or less.

The light emitting module 20 (substrate 21) is adhered to the end 43a1 of the base part 43a. Hence, it is preferable that the end 43a1 of the base part 43a be provided at a position protruding from the bottom surface 11a1 of the recess 11a. If the end 43a1 of the base part 43a protrudes from the bottom surface 11a1 of the recess 11a, it can be suppressed that an adhesive climbs up to the light emitting module 20.

The step 43a2 can be provided at a peripheral edge of the end 43a1 of the base part 43a. The step 43a2 can be provided outside the region where the light emitting module 20 is provided in the heat transfer part 43. The step 43a2 opens to, for example, the end 43a1 of the base part 43a and the peripheral end of the base part 43a. A distance (depth of the step 43a2) between the end 43a1 of the base part 43a and a bottom 43a2a of the step 43a2 may be, for example, about 1 mm. A maximum value (maximum value of a width of the step 43a 2) of the distance between the peripheral end of the base part 43a and a peripheral end of the end 43a1 in the case of being viewed in the direction along the central shaft 1ba of the vehicle lighting device 1b may be, for example, about 10 mm.

The step 43a2 may also be omitted. However, if the step 43a2 is provided, as shown in FIG. 7, the step 43a2 can be embedded inside the socket 10 (mounting part 11). Hence, since the heat transfer area between the base part 43a and the socket 10 can be increased by the depth of the embedded step 43a2, the heat dissipation performance of the heat transfer part 43 can further be improved. Since an adhesion strength between the heat transfer part 43 and the socket 10 can be increased, even if vibration in association with traveling is applied to the vehicle lighting device 1b or thermal stress is generated in association with lighting and extinguishing of the light emitting element 22, it can be suppressed that the heat transfer part 43 falls off from the socket 10 or that the position of the heat transfer part 43 shifts position and predetermined light distribution characteristics cannot be obtained.

The multiple fins 43b are provided at an end 43a3 of the base part 43a that faces the end 43a1. The multiple fins 43b extend inside the socket 10. The multiple fins 43b extend, for example, along the central shaft 1ba of the vehicle lighting device 1b. A tip (end on a side opposite to the end 43a3 side) of the multiple fins 43b is provided inside the socket 10.

In this case, if a distance between the tip of the fin 43b and the heat dissipation fin 14 is reduced, the heat generated in the light emitting module 20 can be efficiently transferred to the heat dissipation fin 14 via the heat transfer part 43. Hence, the heat dissipation performance of the light emitting module 20 can be improved. For example, the tip of the fins 43b is preferably provided inside the flange 13, and more preferably provided inside the heat dissipation fin 14.

The shape of the fin 43b may be, for example, a plate shape or columnar shape. The shape of the fin 43b illustrated in FIG. 6A, FIG. 6B, and FIG. 7 is a plate shape.

For example, the multiple fins 43b can be provided side by side at intervals in one direction. The heat transfer part 43 illustrated in FIG. 6A, FIG. 6B, and FIG. 7 is provided with a fin 43b1 and a fin 43b2 as the multiple fins 43b. For example, at least one fin 43b2 can be provided between a pair of fins 43b1 that face each other in a direction intersecting the central shaft 1ba of the vehicle lighting device 1b. The heat transfer part 43 illustrated in FIG. 6A, FIG. 6B, and FIG. 7 is provided with three fins 43b2. For example, the fin 43b1 and the fin 43b2 can be provided so as to be substantially parallel to each other.

A side part of the fin 43b1 that faces the fin 43b2 adjacent thereto can be inclined. An inclination angle of the side part of the fin 43b1 with respect to the central shaft 1ba of the vehicle lighting device 1b may be, for example, about 1°. A side part of the fin 43b2 that faces the fin 43b2 adjacent thereto, or a side part of the fin 43b2 that faces the fin 43b1 adjacent thereto can be inclined. An inclination angle of the side part of the fin 43b2 with respect to the central shaft 1ba of the vehicle lighting device 1b may be, for example, about 1°.

In the heat transfer part 43 illustrated in FIG. 6A, FIG. 6B, and FIG. 7, the side part of the fin 43b1 and the side part of the fin 43b2 are inclined in a direction in which the cross-sectional area in the direction intersecting the central shaft 1ba of the vehicle lighting device 1b is reduced toward a tip side. The side part of the fin 43b1 and the side part of the fin 43b2 may be inclined in a direction in which the cross-sectional area in the direction intersecting the central shaft 1ba of the vehicle lighting device 1b is increased toward the tip side.

If the side part of the fin 43b1 and the side part of the fin 43b2 are inclined, since the heat transfer area between the fin 43b and the socket 10 can be increased, the heat dissipation performance of the heat transfer part 43 can further be improved.

As shown in FIG. 6A, FIG. 6B, and FIG. 7, a side part 43b1a of the fin 43b1 on a side opposite to the fin 43b2 side may be a curved surface protruding outward. For example, the side part 43b1a of the fin 43b1 may be a curved surface that curves along the peripheral end of the base part 43a. If the side part 43b1a of the fin 43b1 is a curved surface, since the heat transfer area between the side part 43b1a of the fin 43b1 and the socket 10 can be increased, the heat dissipation performance of the heat transfer part 43 can further be improved.

Here, since the fin 43b2 is provided between the fin 43b1 and the fin 43b1, heat released from one fin 43b1 and heat released from the other fin 43b1 enters the fin 43b2. If multiple fins 43b2 are provided, heat released from adjacent fins 43b2 and heat released from adjacent fins 43b1 enter the fin 43b2. Hence, since thermal interference between the fin 43b1 and the fin 43b2 is increased, heat dissipation from the fin 43b2 may be suppressed.

In contrast, in the case of the fin 43b1, only heat released from adjacent fins 43b2 enters the fin 43b1. Hence, thermal interference between the fin 43b1 and the fin 43b2 is reduced. Heat released from the fin 43b1 propagates through the inside of the socket 10 and is released to the outside from the mounting part 11, the flange 13, and the heat dissipation fin 14. Hence, the heat dissipation performance of the fin 43b1 is higher than the heat dissipation performance of the fin 43b2.

In this case, if the cross-sectional area of the fin 43b1 is larger than the cross-sectional area of the fin 43b2 in a direction in which the pair of fins 43b1 and the fin 43b2 are arranged, the surface area of the fin 43b1 can be made larger than the surface area of the fin 43b2, or the thermal resistance of the fin 43b1 can be made smaller than the thermal resistance of the fin 43b2. Hence, the heat dissipation performance of the fin 43b1 can further be improved.

If the heat dissipation performance of the fin 43b1 is improved, the heat generated in the light emitting module 20 can be relatively efficiently transferred to the socket 10. Hence, the temperature of the light emitting element 22 and the circuit element 25 can be effectively prevented from becoming excessively high.

For example, as shown in FIG. 6B, it is sufficient if a maximum dimension T1 (mm) of the fin 43b1 in the direction in which the pair of fins 43b1 and the fin 43b2 are arranged is larger than a maximum dimension T2 (mm) of the fin 43b2.

For example, the maximum dimension T1 (mm) of the fin 43b1 and the maximum dimension T2 (mm) of the fin 43b2 can be set such that “maximum cross-sectional area (mm²) of the fin 43b1/maximum cross-sectional area (mm²) of the fin 43b2” is 1.5 or more.

If multiple fins 43b2 are provided, a maximum dimension between the fin 43b1 and the fin 43b2 can also be made larger than a maximum dimension between the fins 43b2. In this way, since thermal interference between the fin 43b1 and the fin 43b2 can be suppressed, the heat dissipation performance of the fin 43b1 can further be improved.

### Vehicle Lighting Fixture

In one embodiment of the disclosure, the vehicle lighting fixture 100 including the vehicle lighting device 1 can be provided. The description regarding the vehicle lighting device 1 described above and modifications (for example, the vehicle lighting device 1b, or modifications in which a person skilled in the art appropriately adds, deletes, or makes design changes to components and which have the features of the disclosure) of the vehicle lighting device 1 can all be applied to the vehicle lighting fixture 100.

In the following, a case where the vehicle lighting fixture 100 is a front combination light provided in an automobile will be described as an example. However, the vehicle lighting fixture 100 is not limited to a front combination light provided in an automobile. The vehicle lighting fixture 100 may be any vehicle lighting fixture provided in an automobile, a railway vehicle, or the like.

FIG. 8 is a schematic partial cross-sectional view for illustrating the vehicle lighting fixture 100.

As shown in FIG. 8, the vehicle lighting fixture 100 includes, for example, the vehicle lighting device 1 (1b), the housing 101, a cover 102, an optical element 103, a sealing member 104, and the connector 105.

The vehicle lighting device 1 (1b) is attached to the housing 101. The housing 101 holds the mounting part 11. The housing 101 has a box shape with one end side open. The housing 101 is formed from, for example, resin that does not transmit light. On a bottom surface of the housing 101, a mounting hole 101a is provided into which a portion of the mounting part 11 where the bayonet 12 is provided is inserted. At a peripheral edge of the mounting hole 101a, a recess is provided into which the bayonet 12 provided on the mounting part 11 is inserted. Although a case where the mounting hole 101a is directly provided in the housing 101 is illustrated, a mounting member having the mounting hole 101a may be provided on the housing 101.

When the vehicle lighting device 1 (1b) is attached to the vehicle lighting fixture 100, the portion of the mounting part 11 where the bayonet 12 is provided is inserted into the mounting hole 101a, and the vehicle lighting device 1 (1b) is rotated. Then, for example, the bayonet 12 is held by a fitting part provided at the peripheral edge of the mounting hole 101a. Such an attachment method is called a twistlock.

The cover 102 is provided to close the opening of the housing 101. The cover 102 is formed from a light-transmissive resin or the like. The cover 102 may also have functions such as a lens.

Light emitted from the vehicle lighting device 1 (1b) enters the optical element 103. The optical element 103 performs reflection, diffusion, light guiding, light collection, formation of a predetermined light distribution pattern, and the like of the light emitted from the vehicle lighting device 1 (1b). For example, the optical element 103 illustrated in FIG. 8 is a reflector. In this case, the optical element 103 reflects the light emitted from the vehicle lighting device 1 (1b) and forms a predetermined light distribution pattern.

The sealing member 104 is provided between the flange 13 and the housing 101. The sealing member 104 has an annular shape and is formed from an elastic material such as rubber or silicone resin.

When the vehicle lighting device 1 (1b) is attached to the vehicle lighting fixture 100, the sealing member 104 is sandwiched between the flange 13 and the housing 101. Hence, the internal space of the housing 101 can be sealed by the sealing member 104. The bayonet 12 is pressed against the housing 101 by an elastic force of the sealing member 104. Hence, the vehicle lighting device 1 (1b) can be prevented from detaching from the housing 101.

The connector 105 is fitted to the end of the multiple power supply terminals 31 exposed inside the connector holder 15. A lighting circuit or the like provided outside the vehicle lighting fixture 100 is electrically connected to the connector 105. Hence, by fitting the connector 105 to the end of the multiple power supply terminals 31, the lighting circuit or the like and the light emitting element 22 can be electrically connected.

The connector 105 is provided with a sealing member 105a. When the connector 105 including the sealing member 105a is inserted into the inside of the connector holder 15, the inside of the connector holder 15 is sealed to be watertight.

Several embodiments of the disclosure have been illustrated above. However, these embodiments are presented as examples and are not intended to limit the scope of the disclosure. These novel embodiments can be implemented in various other forms, and various omissions, substitutions, changes, and the like can be made without departing from the gist of the disclosure. These embodiments and their modifications are included in the scope and gist of the disclosure, and are also included in the invention described in the claims and the equivalent scope thereof. the aforementioned embodiments can be implemented in combination with each other.

The following shows supplementary notes regarding the aforementioned embodiments.

### Supplementary Note 1

A vehicle lighting device includes: a socket; a light emitting module, provided on one end side of the socket and including a light emitting element; and a heat transfer part, provided between the socket and the light emitting module. In the case of being viewed in a direction along a central shaft of the vehicle lighting device, a contour of the heat transfer part includes an arc protruding outward, and a portion of the heat transfer part including the arc is located outside the light emitting module.

### Supplementary Note 2

In the vehicle lighting device as described in Supplementary Note 1, the contour of the heat transfer part includes the arc, a pair of straight lines each having one end connected to each of both end points of the arc, and a straight line connecting ends on a side of the pair of straight lines opposite to the arc.

### Supplementary Note 3

In the vehicle lighting device as described in Supplementary Note 1, the contour of the heat transfer part includes the arc and a chord connecting both end points of the arc.

### Supplementary Note 4

In the vehicle lighting device as described in Supplementary Note 1, the contour of the heat transfer part includes a shape obtained by notching a portion of a circle.

### (supplementary Note 5

In the vehicle lighting device as described in any one of Supplementary Notes 1 to 4, the heat transfer part further includes at least one fin extending inside the socket.

### Supplementary Note 6

In the vehicle lighting device as described in any one of Supplementary Notes 1 to 5, a step is provided outside a region where the light emitting module is provided in the heat transfer part.

### Supplementary Note 7

A vehicle lighting fixture includes: the vehicle lighting device as described in any one of Supplementary Notes 1 to 6; and a housing to which the vehicle lighting device is attached.

1. A vehicle lighting device, comprising:
a socket formed from highly thermally conductive resin;
a light emitting module, provided on one end side of the socket and including a light emitting element;
a heat transfer part formed from metal, provided between the socket and the light emitting module, wherein
in a case of being viewed in a direction along a central shaft of the vehicle lighting device, a contour of the heat transfer part includes an arc protruding outward, and a portion of the heat transfer part including the arc is located outside the light emitting module,
wherein the contour of the heat transfer part includes the arc, a pair of straight lines each having one end connected to each of both end points of the arc, and a straight line connecting ends on a side of the pair of straight lines opposite to the arc.

2. (canceled)

3. A vehicle lighting device, comprising:
a socket formed from highly thermally conductive resin;
a light emitting module, provided on one end side of the socket and including a light emitting element;
a heat transfer part formed from metal, provided between the socket and the light emitting module, wherein
in a case of being viewed in a direction along a central shaft of the vehicle lighting device, a contour of the heat transfer part includes an arc protruding outward. and a portion of the heat transfer part including the arc is located outside the light emitting module,
wherein the contour of the heat transfer part includes the arc and a chord connecting both end points of the arc.

4. (canceled)

5. The vehicle lighting device as claimed in claim 1, wherein
the heat transfer part further includes at least one fin extending inside the socket.

6. The vehicle lighting device as claimed in claim 1, wherein
a step is provided outside a region where the light emitting module is provided in the heat transfer part.

7. A vehicle lighting fixture, comprising:
the vehicle lighting device as claimed in claim 1; and
a housing to which the vehicle lighting device is attached.

8. The vehicle lighting device as claimed in claim 3, wherein
the heat transfer part further includes at least one fin extending inside the socket.

9. The vehicle lighting device as claimed in claim 3, wherein
a step is provided outside a region where the light emitting module is provided in the heat transfer part.

10. A vehicle lighting fixture, comprising:
the vehicle lighting device as claimed in claim 3; and
a housing to which the vehicle lighting device is attached.

11. A vehicle lighting fixture, comprising:
the vehicle lighting device as claimed in claim 8; and
a housing to which the vehicle lighting device is attached.

12. A vehicle lighting fixture, comprising:
the vehicle lighting device as claimed in claim 9; and
a housing to which the vehicle lighting device is attached.
